(19) United States
(12) Patent Application Publication
(10) Pub. No.: US 2011/0226795 A1
(43) Pub. Date: Sep. 22, 2011

(54) PRODUCT DISPENSING METHOD AND VENDING MACHINE

(76) Inventor: Roberto Sichich, Zanica (IT)

(21) Appl. No.: 12/992,811

(22) PCT Filed: May 14, 2009
(86) PCT No.: PCT/IB2009/005591

§ 371 Date: Jun. 6, 2011

(30) Foreign Application Priority Data
May 15, 2008 (IT) TO2008A000367

(51) Int. Cl. B65D 83/00; B65G 59/00

(52) U.S. Cl. 221/1; 221/133

(57) ABSTRACT

A method and vending machine for dispensing products, whereby a selected product is transferred by a bin from a relative line on a relative tray of the vending machine to a pickup station communicating with the outside through a window having a movable hatch; the bin being moved between a first position, in which the bin receives the selected product, and a second position, in which the bin is located just below the window at the pickup station, so the selected product, once the hatch is opened, can be withdrawn through the window from the outside, directly from the bin arrested in the second position.

### CROSS-REFERENCE TO RELATED APPLICATIONS

This application is a U.S. Nationalization of PCT International Application No. PCT/IB2009/005591 filed 14 May 2009, entitled “PRODUCT DISPENSING METHOD AND VENDING MACHINE”, which claims priority to Italian Patent Application No. TO2008A000367 filed 15 May 2008, the entireties of both the foregoing application are incorporated herein by reference

### TECHNICAL FIELD

Embodiments of the present invention relate to a product dispensing method and vending machine.

### BACKGROUND ART

Product vending machines are known to comprise a casing or similar container defining a compartment closed at the front by a door, which normally comprises a part made of transparent material, and a lateral part defined by a panel or upright made of non-transparent material, such as metal.

The compartment normally houses a number of superimposed trays, which face the transparent part of the door, support respective numbers of products, such as bottles, cans, boxes or bags arranged in lines, and occupy a rear portion of the compartment so as to define a drop shaft between the door and their front ends.

Each line is normally engaged by a respective, normally push-type, conveyor, which is activated selectively by the user to feed the relative products successively to the drop shaft.

The drop shaft of vending machines is known to be fitted inside with a transfer device comprising a bin, and a cartesian actuating system connected to the bin to move the bin, inside the drop shaft, between a loading position, in which the bin is aligned with the line of a selected product to receive the product itself, and a pickup station normally located behind the lateral panel and where the selected product can be withdrawn from the outside through a hatch or similar formed in the lateral panel or otherwise accessible through an opening in the lateral panel.

This prevents damage to the selected products, particularly those off the top trays, by falling freely down the shaft. So far, however, this has only be achieved at the expense of various drawbacks, mainly due to known vending machines of the above type, for example the vending machine disclosed in U.S. Pat. No. 6,415,952, normally comprising a pickup station comprising a compartment accessible from the outside, and into which the selected product must be unloaded for withdrawal from the outside. A pickup station of this sort therefore calls for employing bins of varying configurations and/or automatic systems for transferring the products from the bin to the pickup compartment, thus producing structural and mechanical complications.

### SUMMARY

One or more embodiments of the present invention provide a vending machine product dispensing method that is cheap and easy to implement and, at the same time, provides for reducing or possibly eliminating the aforementioned drawbacks.

According to an embodiment of the present invention, there is provided a vending machine product dispensing method. The method includes transferring a selected product from a relative line of products on a relative tray of the vending machine into a bin located in a first position substantially aligned with the tray and the line. The method further includes moving the bin by means of Cartesian actuating means, along a drop shaft in front of the trays, into a pickup station having a window through which the pickup station communicates with the outside. The window includes a hatch movable between a normal closed position and an open position. The act of moving the bin further includes setting the bin, inside the pickup station, to a second position enabling the selected product to be withdrawn directly from the bin through the window from the outside.

According to an embodiment of the present invention, there is also provided a vending machine for implementing the above-described method. The vending machine includes a casing closed by a front wall, a number of superimposed trays housed inside the casing and supporting relative products arranged in lines on each tray, a drop shaft between the trays and the front wall, a pickup station communicating with the drop shaft and having a window through which the pickup station communicates with the outside, the window having a hatch movable between a normal closed position and an open position, and a transfer device for feeding a selected product from a respective line to the pickup station. The transfer device includes a bin for receiving a product from a respective line and transferring it to the pickup station, and a Cartesian actuating unit housed inside the drop shaft to actuate the bin. The pickup station is designed to define, for the bin, a pickup position enabling the selected product to be withdrawn directly from the bin through the window from the outside.

### BRIEF DESCRIPTION OF THE DRAWINGS

A number of non-limiting embodiments of the present invention will be described by way of example with reference to the accompanying drawings, in which:

FIG. 1 shows a schematic view in perspective of a first preferred embodiment of the vending machine according to the present invention;

FIG. 2 shows a schematic front view of the inside of the FIG. 1 vending machine;

FIG. 3 shows a larger-scale, schematic view in perspective, from the inside, of a first detail in FIG. 2;

FIG. 4 shows a larger-scale, partial schematic view in perspective of a second detail in FIG. 2;

FIG. 5 shows a front view, with parts removed for clarity, of a second preferred embodiment of the vending machine according to the present invention;

FIG. 6 shows a larger-scale, schematic cross section of a detail in FIG. 5;

FIGS. 7 and 8 show respective alternative preferred embodiments of a detail in FIG. 6.

### DETAILED DESCRIPTION

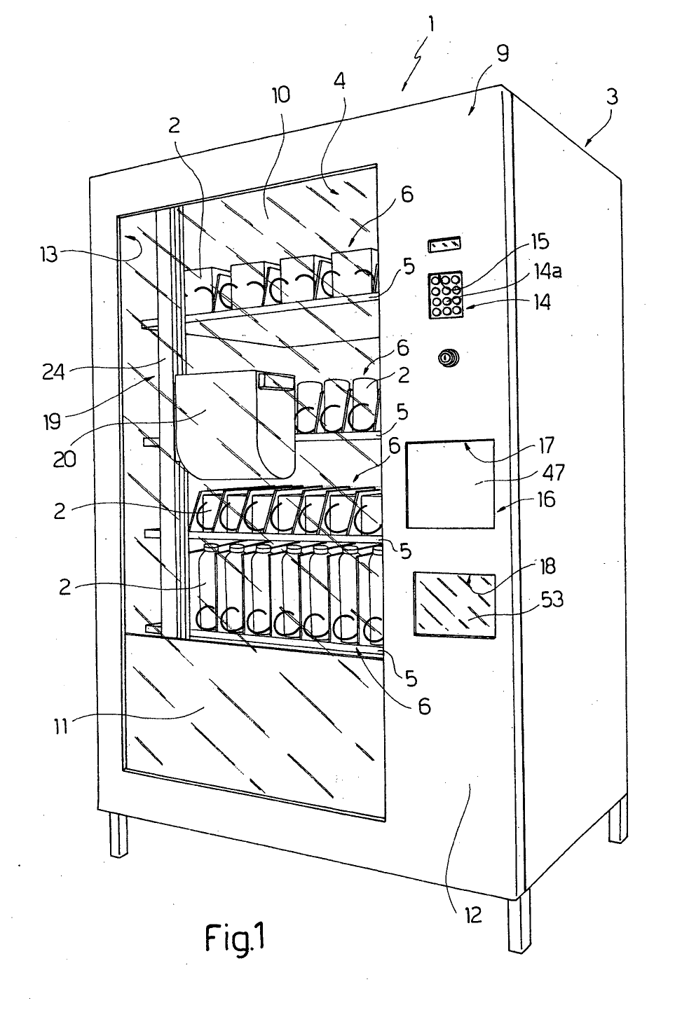

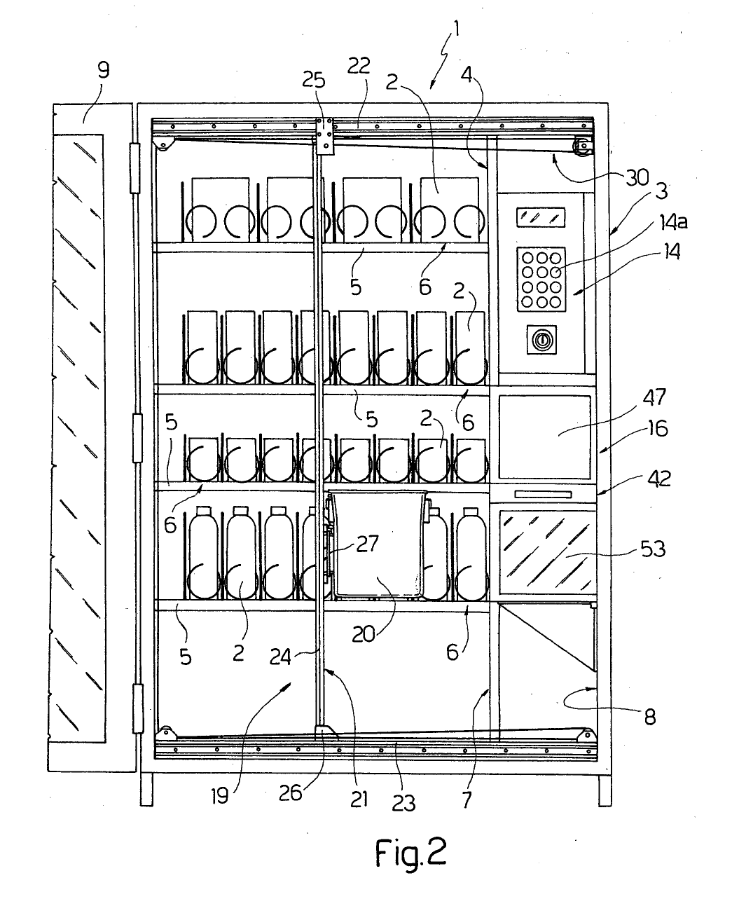

Number 1 in FIGS. 1 and 2 indicates as a whole a vending machine for products 2, comprising a casing 3 defining a top compartment 4 housing a number of superimposed trays 5, each supporting a number of side by side lines 6 of products 2; a compartment 7 beneath compartment 4; and a compartment 8 alongside compartments 4 and 7.

As shown in FIG. 1, casing 3 is closed at the front by a front wall defined by a door 9, which comprises a top lateral portion 10 made of transparent material and facing compartment 4; a lateral portion 11 made of non-transparent material and facing compartment 7; and a lateral portion made of non-transparent material, such as metal, and defined by a panel 12 facing compartment 8.

With the front ends of trays 5, door 9 defines a substantially vertical drop shaft 13, to which user-selected products 2 are fed by known push conveyors (defined, in the example shown, by screw conveyors).

As shown in FIG. 2, behind panel 12, shaft 13 houses a control station 14 comprising a pushbutton panel 14a accessible through a window 15 in panel 12; and a pickup station 16, a top portion of which is accessible through a window 17 in panel 12, and a bottom portion of which is visible from the outside through an optional window 18 formed through panel 12, just below window 17.

Vending machine 1 also comprises a transfer device 19 housed inside shaft 13, and which receives a selected product 2 expelled from the end of relative line 6, and transfers the product 2 to pickup station 16.

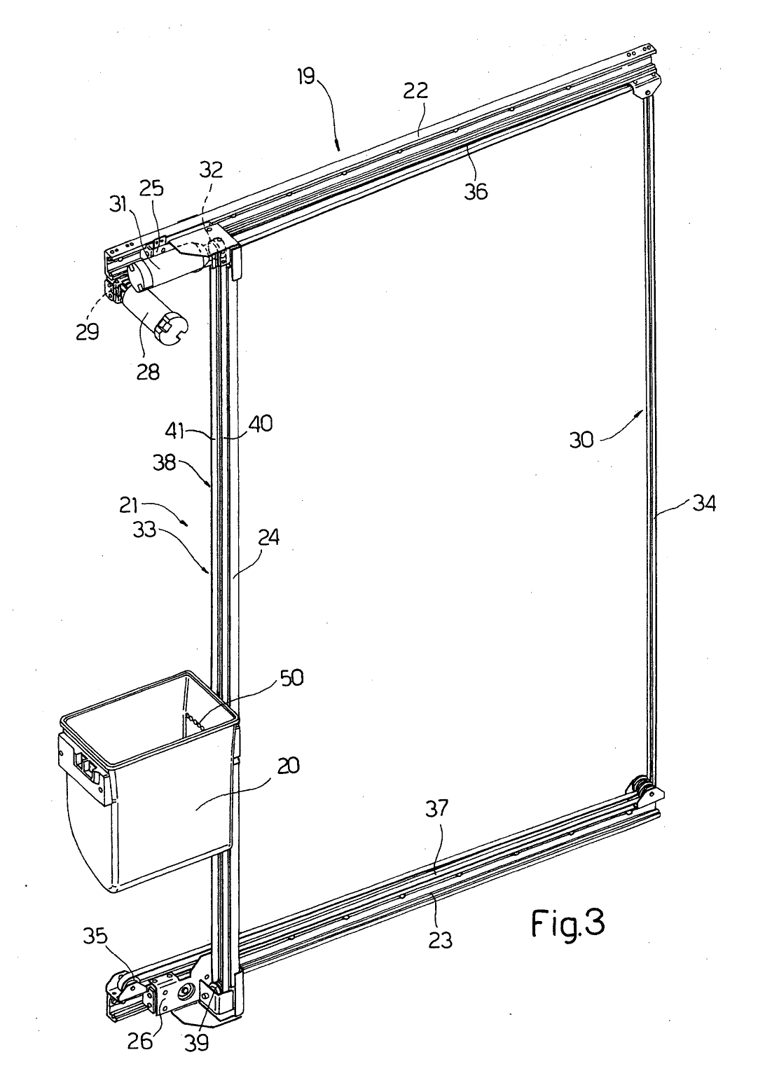

As shown more clearly in FIG. 3, transfer device 19, which may be mounted in a fixed position or on door 9, comprises an open-topped bin 20 for receiving the selected product 2, and which is positioned parallel to the plane of door 9, with its concavity facing upwards. Transfer device 19 also comprises a cartesian actuating unit 21 housed inside shaft 13 and for moving bin 20 between any two positions along shaft 13 and in particular to and from pickup station 16.

Actuating unit 21 comprises two horizontal runners 22 and 23, which are parallel to the plane of door 9, are located inside shaft 13, along a top edge and a bottom edge of door 9 respectively, and extend substantially the whole width of door 9; and a vertical runner 24, which has a top carriage 25 mounted to run along runner 22, and a bottom carriage 26 mounted to run along runner 23, and supports a slide 27 that slides along a surface of runner 24 facing pickup station 16, and in turn supports bin 20 projecting from slide 27 towards pickup station 16.

Actuating unit 21 also comprises a motor 28 fitted to the end of runner 22 behind panel 12, and fitted with a pulley 29 having an axis perpendicular to the plane of door 9, and for operating a belt drive 30 for moving runner 24 along runners 22 and 23; and a motor 31 fitted to the top end of runner 24, and fitted with a pulley 32 for operating a belt drive 33 for moving slide 27 along runner 24.

Belt drive 30 comprises an endless belt 34, which is looped about pulley 29 and about a further pulley 35 fitted to runner 23, and is divided by pulleys 29 and 35 into two branches 36 and 37 connected to respective carriages 25 and 26, so that movement of carriage 25 along runner 22 corresponds to an equal movement of carriage 26 in the same direction along runner 23.

Belt drive 33 comprises an endless belt 38, which is looped about pulley 32 and about a further pulley 39 fitted to runner 24, close to carriage 26, and is divided by pulleys 32 and 39 into two branches 40 and 41, of which branch 40 is connected to slide 27 so that rotation of pulley 32 corresponds to a vertical movement of slide 27, and hence bin 20, along runner 24.

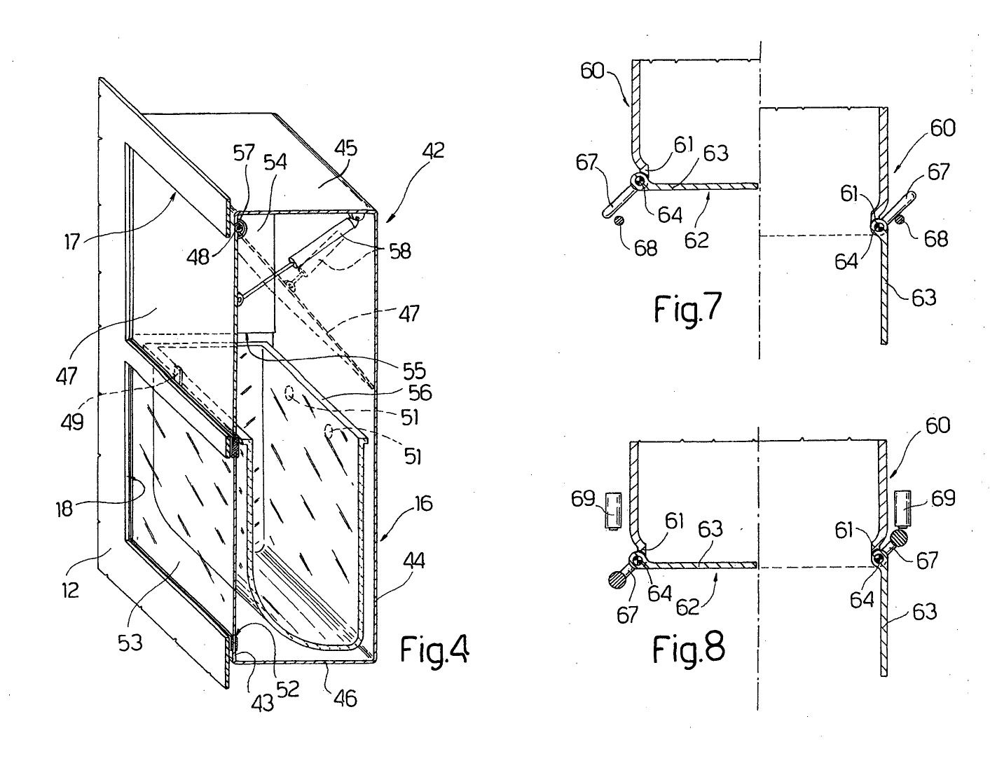

Finally, as shown more clearly in FIG. 4, pickup station 16 is defined by a rectangular parallelepiped-shaped box 42, which is normally made of metal, is located in a fixed position inside shaft 13 and behind panel 12, and comprises a front wall 43 parallel to panel 12 and facing windows 17 and 18; a rear wall 44 parallel to front wall 43; and a horizontal top wall 45 and bottom wall 46 connecting front and rear walls 43 and 44 to each other. Front wall 43 has a window, which is located at window 17, is slightly taller than window 17, and is closed by a hatch 47, a top edge of which is connected to wall 43 by a horizontal-axis hinge 48 parallel to panel 12, and a bottom edge of which is located below the bottom edge of window 17, so hatch 47 can only rotate inwards of box 42 to and from a vertical closed position, in which a bottom edge of hatch 47 rests against the inner surface of panel 12.

Hatch 47, which may be made of transparent material, is normally locked in the closed position by a lock 49, which is movable to and from a release position, in which lock 49 allows hatch 47 to rotate inwards of box 42. The lock is normally released by a known actuating device (not shown), preferably a timed electromagnetically operated device, which can only be activated by control station 14 upon receiving a consent signal from sensors 50 fitted to bin 20 and for detecting the presence of a product 2 inside bin 20, and from sensors 51 fitted inside box 42 and for detecting the presence of bin 20 at pickup station 16.

A window 52 is formed in front wall 43, below hatch 47, is taller than bin 20, is located facing window 18, and is closed by a transparent panel 53 that also closes window 18.

Box 42 is closed laterally, on the side facing compartments 4 and 7, by a lateral wall 54, a bottom portion of which is removed to define a window 55, which forms an inlet for bin 20 into pickup station 16, is at least as tall as bin 20, is bounded at the bottom by bottom wall 46, has a top edge on a level just below that of the bottom edge of hatch 47, is equal in width to the distance between front wall 43 and rear wall 44, and is slightly wider than the width of a top frame 56 of bin 20.

Operation of vending machine 1 will now be described as of a start rest position, in which bin 20 may be stationary at any point along shaft 13. In the following description, however, reference is made to a preferred start position, which is an end-of-cycle pickup position, in which runner 24 is positioned behind panel 12 and substantially contacting the outer surface of lateral wall 54, and bin 20 is empty and inserted completely inside box 42 through window 55. The above position of window 55 defines, for bin 20 inside box 42, a pickup position, in which bin 20 is positioned with its top frame 56 on a level just below that of the top edge of window 55 and the bottom edge of hatch 47. In this pickup position, bin 20 divides the inside of box 42 into two substantially non-communicating portions: a top portion which communicates with the outside through the window closed by hatch 47; and a bottom portion that houses bin 20, defines the pickup position, and communicates with shaft 13 through window 55.

When bin 20 is in the end-of-cycle pickup position described above, lock 49 is in the lock position locking hatch 47 in the closed position.

When a product 2 is selected on pushbutton panel 14a, control station 14 activates motors 28 and 31 to move bin 20 into, and stop it in, a loading position, in which top frame 56 of bin 20 is just below the level of the tray 5 supporting the selected product 2, and aligned with line 6 containing the selected product 2. Next, control station 14 activates the push device (in the example shown, a known screw push device) to drop the selected product 2 into bin 20. The presence of selected product 2 inside bin 20 is detected by sensors 50, which send a first consent signal to control station 14, which in turn activates motors 28 and 31 to return bin 20 to the pickup position. Accordingly, sensors 51 emit a second consent signal, on receiving which control station 14 cuts off current supply to motors 28 and 31, and moves lock 49 into the release position, so the user, seeing bin 20 in the pickup position through transparent panel 53, can tilt hatch 47 manually inwards in opposition to a spring 57, and insert a hand through window 17 to withdraw the selected product directly from bin 20.

Once the product is withdrawn, hatch 47 is closed by spring 57, and can be opened again for a time t1 after it is closed. At the end of time t1, lock 49 is locked, and hatch 47 cannot be opened again.

Microswitches or similar sensors (not shown) check hatch 47 is actually closed and lock 49 actually locked. If hatch 47 is held open, e.g. by inserting a foreign object, for a given time t2 longer than time t1, lock 49 is not moved into the lock position, and control station 14 continues to cut off current supply to motors 28 and 31, so transfer device 19 remains deactivated. The same also applies if, when hatch 47 is closed, lock 49, for any reason, fails to move into the lock position.

By way of an alternative to manual opening of hatch 47 as described above, spring 57 may be combined with an actuator 58.

In which case, bin 20 and selected product 2 reaching the pickup position inside pickup station 16 activates actuator 58, which opens hatch 47 and keeps it open for a time t3, shorter than time t1, before closing it. The hatch may be opened manually by the user before time t1 expires.

In this case too, control station 14 continues to cut off power to motors 28 and 31, in the event hatch 47 is not closed by the end of time t2 and/or lock 49 fails to move into the lock position.

In other words, in the pickup position just below the bottom edge of hatch 47, bin 20 not only enables selected product 2 to be withdrawn manually straight from bin 20, thus eliminating the need for, and the mechanical complications involved in, transferring selected product 2 from bin 20 to a pickup position, but also engages box 42 in such a manner as to prevent break-in.

Though bin 20 in the pickup position prevents products 2 on trays 5 from being reached from the outside through pickup station 16 and/or foreign objects from being inserted inside shaft 13, it obviously cannot prevent foreign objects from being inserted inside bin 20 itself, once the selected product 2 has been withdrawn, with all the drawbacks this entails.

As shown in FIG. 6, to minimize the consequences of vandalism of this sort, the closed-bottom bin 20 described above is replaced by a bin 60 comprising a bottom frame 61, and a bottom wall 62 that opens to dump any inserted foreign objects or, possibly, a selected product 2 not withdrawn within hold time t3 of bin 60 in the pickup position and after timed return of lock 49 to the lock position locking hatch 47.

In the FIG. 6 example, bottom wall 62 is defined by two panels 63 connected to bottom frame 61 by respective hinges 64 to rotate in opposite directions, in opposition to springs not shown, from a coplanar closed position, in which the two panels 63 form bottom wall 62, to an open position, in which the two panels 63 are positioned substantially vertically downwards.

If bin 60 is used, bottom wall 46 of the box is preferably eliminated to allow bin 60 to move vertically downwards from the pickup position and, as shown in FIG. 5, into a dump position over an open-topped container 65 inside compartment 8 beneath pickup station 16. Alternatively, bin 60 is moved both horizontally and vertically into a dump position over an open-topped container 66 inside compartment 7, which, being larger than compartment 8 beneath pickup station 16, can house a larger container.

Panels 63 can be opened automatically in the dump position by providing panels 63 with outer appendixes 67 (FIG. 7) which are intercepted by respective fixed actuators 68 as bin 60 moves down into the dump position.

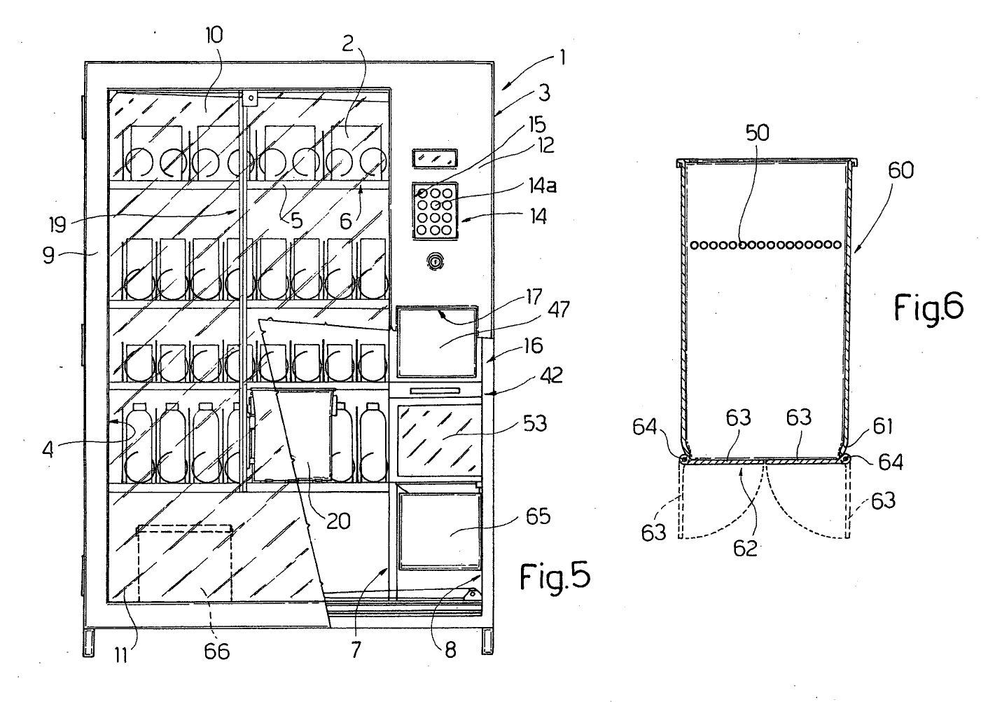

If appendixes 67 are made of metal, panels 63, as shown in the FIG. 8 variation, can be opened in the dump position by acting on appendixes 67 by means of electromagnets 69.

In other words, if bin 60 is used, the operating cycle of transfer device 19 comprises, as of the pickup position, a dump step, which comprises setting bin 60 to the dump position over container 65 or 66, and opening bottom wall 62.

1) A method of dispensing products (2) from a vending machine (1), the method comprising:
a step of transferring a selected product (2) from a relative line (6) of products (2) on a relative tray (5) of the vending machine (1) into a bin (20; 60) located in a first position substantially aligned with said tray (5) and said line (6); and
a step of moving the bin (20; 60), along a drop shaft (13) in front of the trays (5), into a pickup station (16) having a window (17) through which the pickup station (16) communicates with the outside; the window (17) comprising a hatch (47) movable between a normal closed position and an open position;
the method being characterized in that the step of moving the bin (20; 60) comprises a step of setting the bin (20; 60), inside the pickup station (16), to a second position enabling the selected product (2) to be withdrawn directly from the bin (20; 60) through the window (17) from the outside.

2) A method as claimed in claim 1, wherein the bin (20; 60) in the second position is located just below the window (17).

3) A method as claimed in claim 1 or 2, wherein the step of moving the bin is performed by cartesian actuating means (21).

4) A method as claimed in one of the foregoing claims, and comprising a further step of moving the bin (20; 60) from the second position to a third position, in which to dump any objects inside the bin (20; 60) into a container (65; 66) inside the vending machine (1).

5) A method as claimed in claim 4, wherein the further step of moving the bin comprises exclusively vertical movements of the bin (20; 60).

6) A method as claimed in claim 4, wherein the further step of moving the bin comprises both vertical and horizontal movements of the bin (20; 60).

7) A vending machine implementing the method as claimed in one of the foregoing claims, the vending machine (1) comprising a casing (3) closed by a front wall (9); a number of superimposed trays (5) housed inside the casing (3) and supporting relative products (2) arranged in lines (6) on each tray; a drop shaft (13) between the trays (5) and the front wall (9); a pickup station (16) communicating with the drop shaft (13) and having a window (17) through which the pickup station (16) communicates with the outside, the window (17) having a hatch (47) movable between a normal closed position and an open position; and a bin (20; 60) for receiving a product from a respective line (6) and transferring it to the pickup station (16); the vending machine (1) being characterized in that the pickup station (16) is designed to define, for the bin (20; 60), a pickup position enabling the selected product (2) to be withdrawn directly from the bin (20; 60) through the window (17) from the outside.

8) A vending machine as claimed in claim 7, wherein the bin (20; 60) in the Pickup position inside the pickup station (16) is located just below the window (17).

9) A vending machine as claimed in claim 7 or 8, and comprising a transfer device (19) for feeding a selected product (2) from a respective line (6) to the pickup station (16); the transfer device (19) comprising the bin (20; 60), and a cartesian actuating unit (21) housed inside the drop shaft (13).

10) A vending machine as claimed in one of claims 7 to 9, wherein the pickup station (16) comprises a box (42) having a top portion communicating with the outside through said window (17), and a bottom portion communicating with the drop shaft (13) through a further window (55) and defining the pickup position.

11) A vending machine as claimed in claim 10, wherein the bottom portion is bounded at least partly, on the side facing the front wall (9), by a transparent panel (53) through which the bin (20; 60) in the pickup position can be seen from the outside.

12) A vending machine as claimed in one of the foregoing claims, wherein the bin (60) has a bottom wall (62) defined by members (63) movable by external actuating means (68; 69) from a normal closed position to an open dump position.

13) A vending machine as claimed in claim 12, and comprising at least one container (65; 66) for receiving waste from the bin (20; 60).

14) A vending machine as claimed in claim 13, wherein the container (65; 66) is housed inside the casing (3), at a lower level than the pickup position.
